(19) United States
(12) Patent Application Publication
(10) Pub. No.: US 2026/0091941 A1
(43) Pub. Date: Apr. 2, 2026

(54) SPROCKET AND ROLLERS FOR LOG CHAIN CONVEYOR MECHANISM OF AN AUTOMATIC CARWASH SYSTEM

(71) Applicant: Triumph Car Wash Parts Limited, Oakville (CA)

(72) Inventors: Vincent A. MacNeil, Oro-Medonte (CA); Timothy Clinton Justice, Oakville (CA)

(21) Appl. No.: 19/340,134

(22) Filed: Sep. 25, 2025

Related U.S. Application Data
(60) Provisional application No. 63/702,068, filed on Oct. 1, 2024.

(51) Int. Cl. B65G 23/06; B60S 3/00; B65G 17/42

(52) U.S. Cl. CPC B65G 23/06; B60S 3/004; B65G 17/42

(57) ABSTRACT

A sprocket for guiding or driving a conveyor chain of a carwash conveyor includes a sprocket ring and first and second support rings flanking opposite sides of the sprocket ring. Flanges on the first and second support rings are spaced apart axially from the sprocket ring so as to form a channel between the flanges that receives drive links of the conveyor chain. The first and second support rings and flanges thereof support a portion of a roller assembly of the carwash conveyor to thereby limit lateral tilting of the roller assembly and/or twisting of the conveyor chain. Also disclosed is a reversible roller assembly including a double-nosed lug, which can be reversed relative to the conveyor chain to extend the service life of the roller assembly.

### RELATED APPLICATION

This application claims the benefit of priority under 35 U.S.C. § 119 (e) from U.S. Provisional Patent Application No. 63/702,068, filed Oct. 1, 2024, which is incorporated by reference herein.

### TECHNICAL FIELD

The field of the present disclosure relates to automatic carwash conveyors utilizing a log chain style drive mechanism and, in particular, sprockets and roller assemblies for such conveyors.

### BACKGROUND

Automatic carwash conveyor systems utilizing a loop of log chain in the drive mechanism are well known, as described for example in U.S. Pat. No. 11,260,833 of Belanger et al. Multiple roller assemblies (also known as dollies or simply as rollers) are coupled to the log chain at intervals along the loop of log chain and include a linkage body and roller wheels. The roller assemblies may be selectively called up by a call-up mechanism of the conveyor system to ride along the top of a deck of the conveyor for pushing an automobile or other vehicle through the carwash. When not called up, the roller assembly is carried by the chain below the deck of the conveyor system to reduce wear and tear. Such conveyor systems are commonly known as over/under conveyors because the rollers may ride over the deck when conveying a vehicle, or may be carried with the chain under the deck when not conveying a vehicle.

One of the simplest and most reliable roller assemblies, commonly known as the MacNeil-style roller assembly, is depicted in U.S. Design Pat. No. D293,953 of MacNeil and consists essentially of (i) a forged steel roller lug with a chain link, (ii) a single steel axle pin supported on the lug, (iii) two large-diameter pusher rollers (aka pusher roller wheels) rotatably mounted on the axle pin on either side of the lug which ride in a slot formed in the deck of the conveyor, and (iv) two smaller-diameter deck-engaging main rollers (aka main roller wheels or outrigger wheels) mounted on the axle pin outboard of the pusher rollers. The pusher rollers and main rollers are typically made of polymer material, such as polyurethane or ultra-high molecular weight polyethylene (UHMWPE) for high strength, low friction, chemical resistance, and wear resistance. The pusher rollers engage the backside of a tire of the automobile being conveyed and counter-rotate relative to the tire and the deck-engaging main rollers as the automobile is conveyed. Variants on the classic MacNeil style roller assembly may include a pair of stabilizer rollers mounted outboard of the main rollers which help prevent the tire from contacting the deck-engaging main rollers. One such variant of this kind is described in U.S. Pat. No. 7,243,605 of Belanger et al.

MacNeil roller assemblies were originally developed for use with a drop-forged rivetless bar-link drive chain, which is flexible in only a single direction and provides lateral stability for the roller assembly as it is conveyed over a drive sprocket and other sprockets of the conveyor system. Lugs for MacNeil-style roller assemblies have been adapted for use with less-expensive log chain, as illustrated in U.S. Pat. No. 11,260,833, but because log chain is flexible in multiple directions and can twist along its length it provides little lateral stability for the roller assembly. The present inventors have determined that the reduced lateral stability provided by log chain conveyor systems can be a source of wear and tear in the conveyor system and can lead to jamming or other malfunctions, particularly as the roller assembly is carried over a drive sprocket, idler sprocket, or tensioning sprocket of the conveyor system.

Accordingly, the present inventors have identified a need for improved sprockets and roller assemblies for use with log chain drive mechanisms of carwash conveyor systems.

### BRIEF DESCRIPTION OF THE DRAWINGS

A detailed description of preferred embodiments proceeds with reference to the accompanying drawings listed below. Identical reference numbers appearing in multiple figures of the drawings refer to the same element throughout.

FIG. 1 is a side view of a portion of a conveyor mechanism of a carwash system including a log chain, a roller assembly, and a drive sprocket, in which an axle pin and roller wheels of the roller assembly are omitted to show details of the log chain as it is engaged by the drive sprocket.

FIG. 2 is a section view of the sprocket and log chain of FIG. 1 taken along line 2-2 and further illustrating how the sprocket is bolted onto a motor drive shaft of the conveyor mechanism.

FIG. 3 is a section view of the sprocket of FIG. 1 taken along line 3-3 and illustrating the roller assembly as it rides over the sprocket.

FIG. 4 is a perspective view of the sprocket of FIGS. 1-3.

FIG. 5 is an end view of the sprocket of FIG. 4;

FIG. 6 is a side view of the sprocket of FIG. 4;

FIG. 7 is a section view of the sprocket of FIG. 4 taken along line 7-7 of FIG. 6.

FIG. 8 is a perspective view of a roller assembly according to a first embodiment for use with the conveyor mechanism of FIGS. 1-3;

FIG. 9 is a partially-exploded assembly view of the roller assembly of FIG. 8.

FIG. 10 is a front end view of the roller assembly of FIG. 8, a rear view thereof being identical.

FIG. 11 is a left side view of the roller assembly of FIG. 8.

FIG. 12 is a right side view of the roller assembly of FIG. 8.

FIG. 13 is a top view of the roller assembly of FIG. 8.

FIG. 14 is a bottom view of the roller assembly of FIG. 8.

FIG. 15 is a perspective view of a lug of the roller assembly of FIG. 8.

FIG. 16 is a left side view of the lug of FIG. 15, a right side view thereof being identical.

FIG. 17 is a front end view of the lug of FIG. 15, a rear view thereof being identical.

FIG. 18 is a top view of the lug of FIG. 15.

FIG. 19 is a bottom view of the lug of FIG. 15.

FIG. 20 is a perspective view of a roller assembly according to a second embodiment for use with the drive mechanism of FIGS. 1-3.

FIG. 21 is a front end view of the roller assembly of FIG. 20, a rear view thereof being identical.

FIG. 22 is a left side view of the roller assembly of FIG. 20.

FIG. 23 is a right side view of the roller assembly of FIG. 20.

FIG. 24 is a top view of the roller assembly of FIG. 20.

FIG. 25 is a bottom view of the roller assembly of FIG. 20.

FIG. 26 is a perspective view of a lug of the roller assembly of FIG. 20.

FIG. 27 is a left side view of the lug of FIG. 26, a right side view thereof being identical.

FIG. 28 is a front end view of the lug of FIG. 26, a rear view thereof being identical.

FIG. 29 is a top view of the lug of FIG. 26.

FIG. 30 is a bottom view of the lug of FIG. 26.

FIG. 31 is a perspective view of a roller assembly according to a third embodiment for use with the drive mechanism of FIGS. 1-3.

FIG. 32 is a front end view of the roller assembly of FIG. 31, a rear view thereof being identical.

FIG. 33 is a left side view of the roller assembly of FIG. 31.

FIG. 34 is a right side view of the roller assembly of FIG. 31.

FIG. 35 is a top view of the roller assembly of FIG. 31.

FIG. 36 is a bottom view of the roller assembly of FIG. 31.

FIG. 37 is a perspective view of a lug of the roller assembly of FIG. 31.

FIG. 38 is a left side view of the lug of FIG. 37, a right side view thereof being identical.

FIG. 39 is a front end view of the lug of FIG. 37, a rear view thereof being identical.

FIG. 40 is a top view of the lug of FIG. 37.

FIG. 41 is a bottom view of the lug of FIG. 37.

### DETAILED DESCRIPTION OF PREFERRED EMBODIMENTS

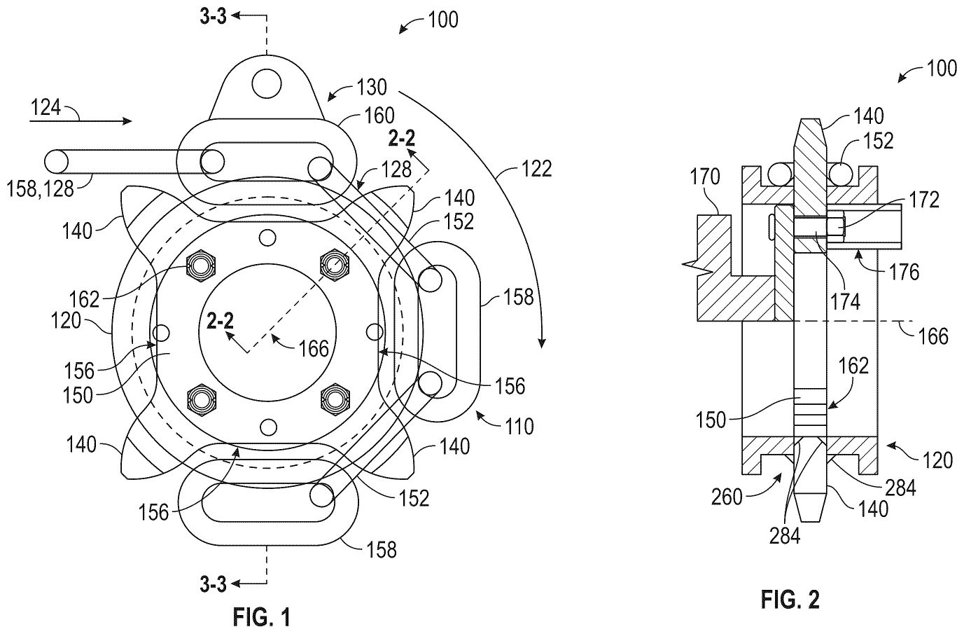

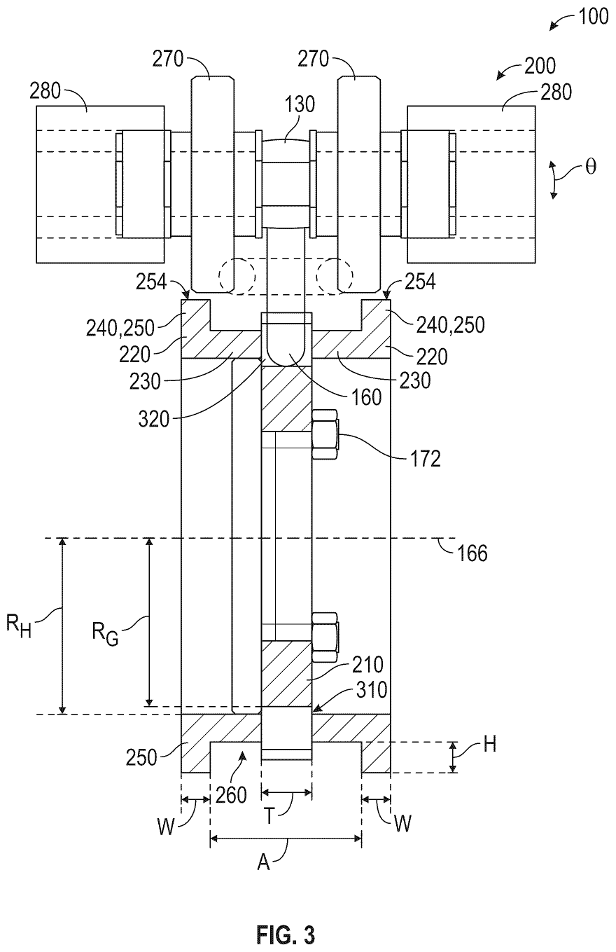

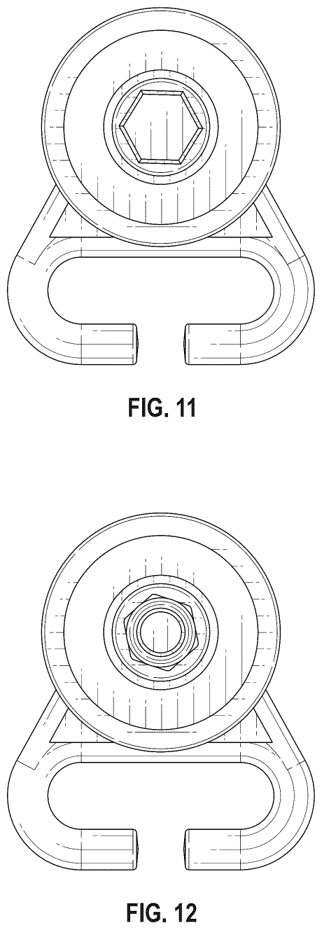

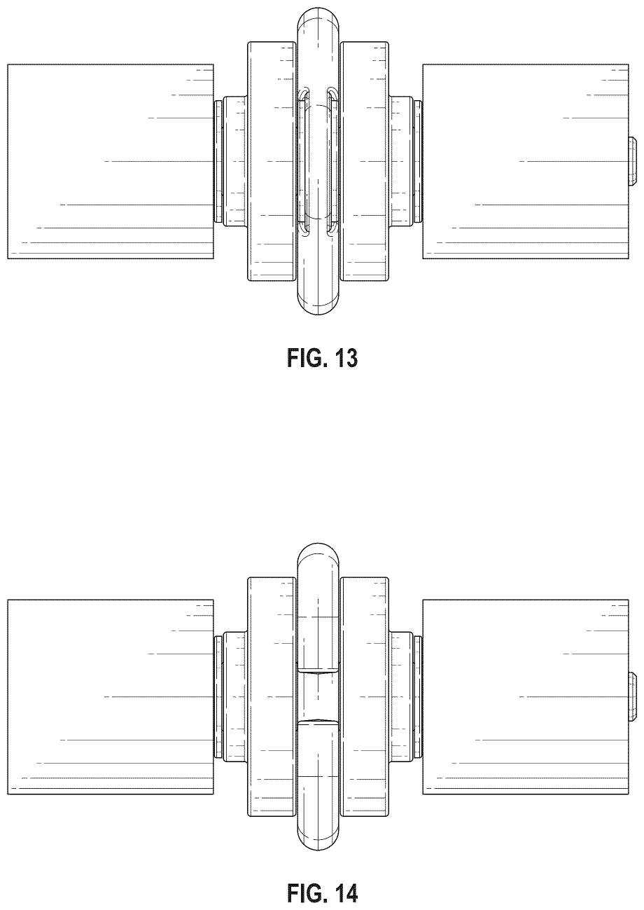

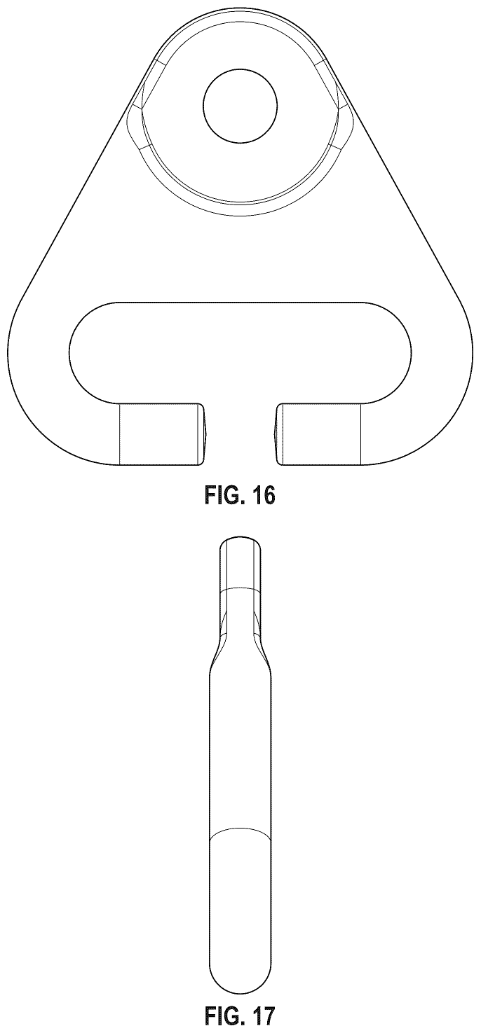

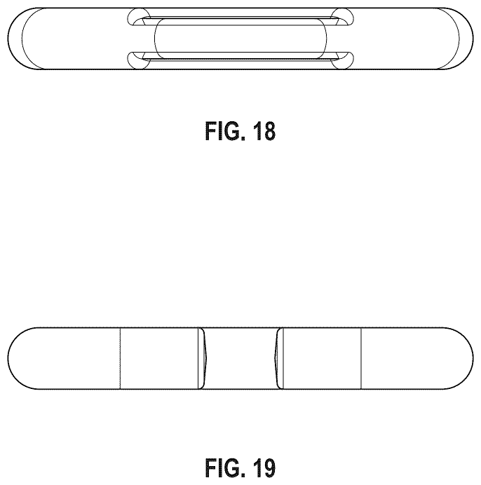

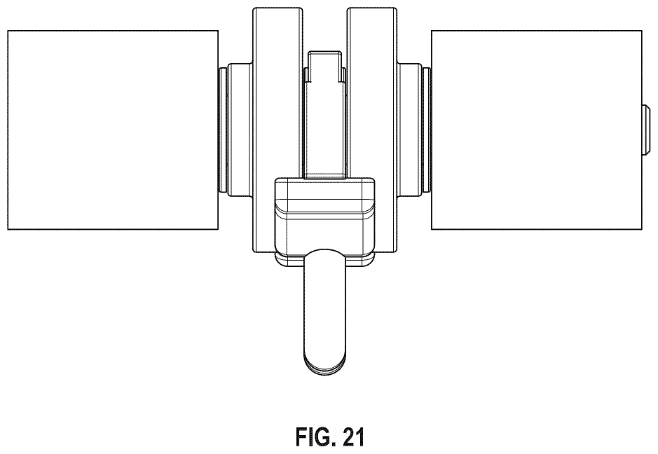

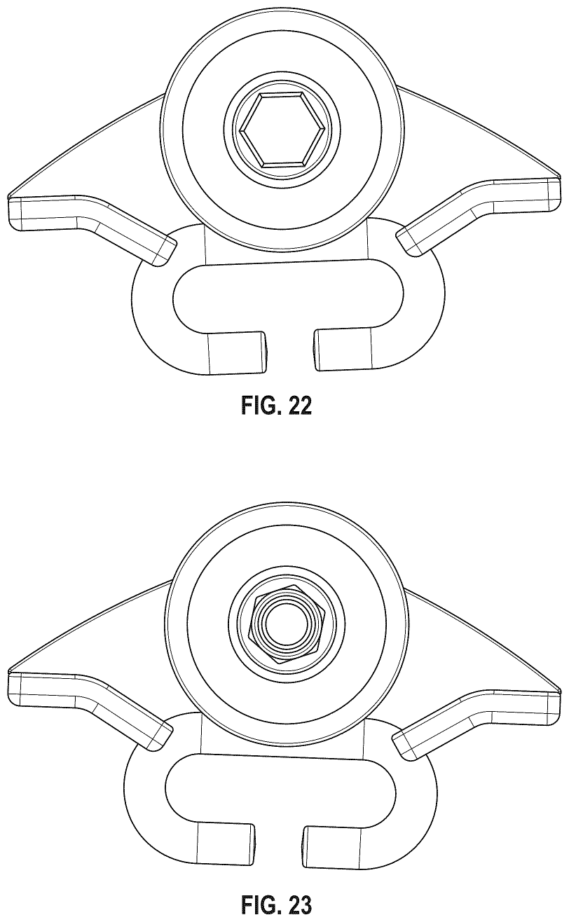

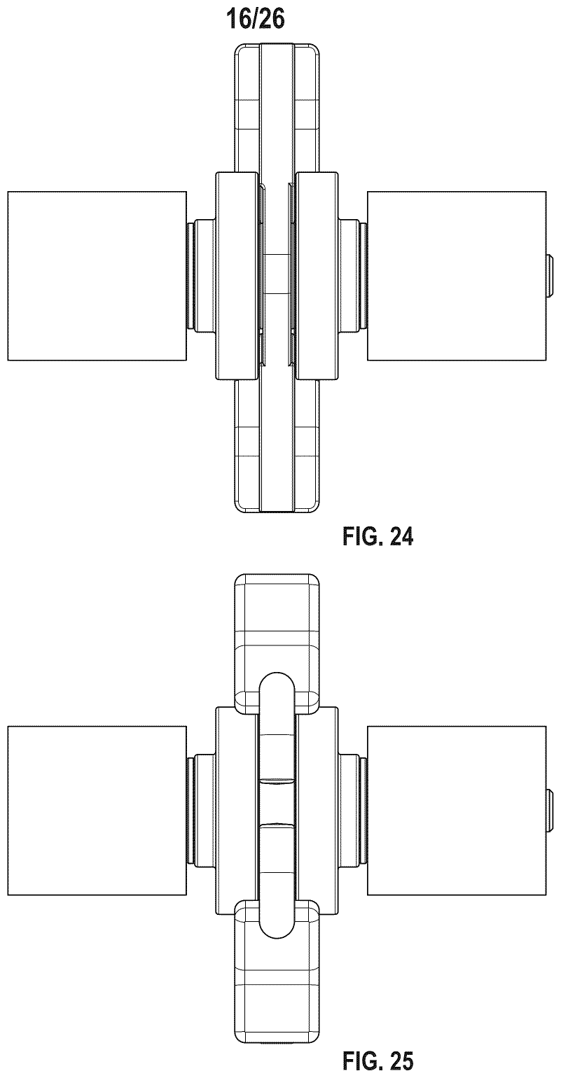

FIG. 1 illustrates a portion of a conveyor mechanism 100 of an automatic carwash system for conveying an automobile through a carwash tunnel or other region of the automatic carwash system. With reference to FIG. 1, conveyor mechanism 100 includes a conveyor loop 110 comprising a chain entrained around a sprocket 120 of the conveyor mechanism. Sprocket 120 is illustrated as a drive sprocket that is rotatably driven by a motor (not illustrated) in the direction indicated by arrow 122 so that sprocket pulls conveyor loop 110 in a conveying direction 124. A sprocket of the same or similar design as sprocket 120 could be utilized as an idler sprocket or tensioning sprocket in the conveyor mechanism 100. Conveyor loop 110 includes multiple segments of chain 128 connected by lugs 130 of roller assemblies 200, examples of which are illustrated in FIGS. 3 and 8-25. Each segment of chain 128 includes multiple links 152, 158, described below. For simplicity, only two segments of chain 128 and one lug 130 are illustrated in FIG. 1, but skilled persons will understand that the conveyor mechanism 100 includes a driven conveyor loop 110 comprised of connected segments of chain 128 and roller assemblies 200 and that conveyor loop 110 extends substantially through the automatic carwash along a deck (not illustrated) of the conveyor mechanism 100 over which a tire of the automobile rides when being conveyed. The chain 128 may be standard ⅝ inch (16 mm) steel log chain of grade 70 or better, with a pitch of 3.5 inch, for example. In other embodiments, the log chain may be a different size or grade. In still other embodiments, the segments of chain 128 may be formed of another type of chain other than log chain. The conveyor loop carries roller assemblies at intervals typically in the neighborhood of 2 to 4 feet apart (0.6 to 1.2 m), and may include dozens of segments of chain 128, each segment including approximately 7 to 14 links 152, 158 of log chain and being connected at its ends by coupling portions 160 of the lugs 130 of the roller assemblies 200—altogether forming a loop (conveyor loop 110) that is entrained around drive sprocket 120 located proximate a forward end of conveyor mechanism 100 near an exit of the automatic carwash and an idler sprocket (not illustrated) located proximate a rearward end of conveyor mechanism 100 near an entrance of the automatic carwash. The total length of the conveyor loop 110 and conveyor mechanism 100 will depend on the length of the tunnel or other washing and drying region of the automatic carwash system. In some carwash systems the conveyor mechanism 100 may be between approximately 75 and 150 feet long (approximately 23 to 46 m), with a conveyor loop 110 having a total length of approximately double the conveyor length, i.e., between approximately 150 and 300 feet long (approximately 46 to 92 m).

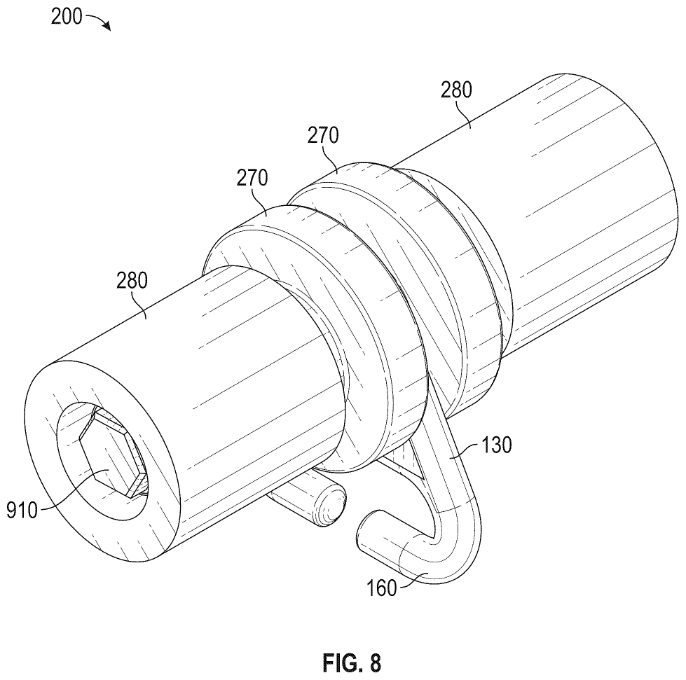

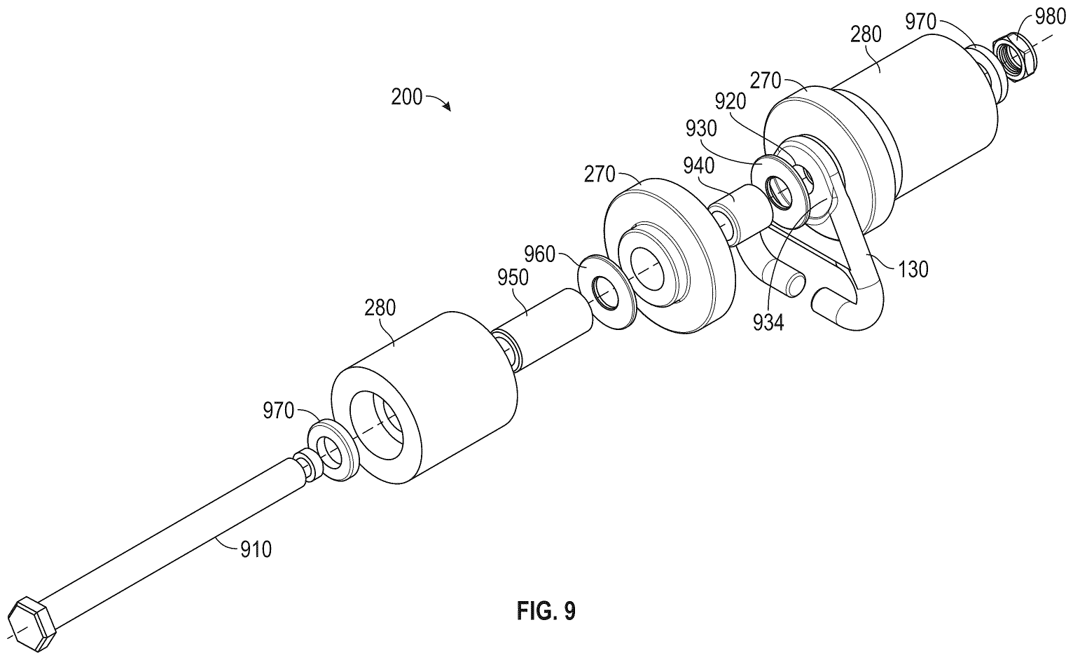

Coupling portions 160 of lugs 130 may be generally C-shaped-having an opening in the center of their length, as best illustrated in FIGS. 8-25 and further discussed below with reference to FIGS. 8 and 9, which allows roller assemblies 200 to be readily attached to and detached from adjacent segments of chain 128 without the use of tools. Note that FIG. 1 schematically illustrates coupling portions 160 as an endless loop for dimensional purposes, as the C-shaped coupling portions 160 (with openings illustrated in FIGS. 8-25) follow the same general oval shape as the oval toroid links 152, 158 in the chain 128. Each of the links 152, 158 of a ⅝″ log chain with 3.5 inch pitch, as commonly used in carwash conveyors, has an oval shape with an exterior length of approximately 4.73 inches (120 mm), an exterior width of approximately 2.43 inches (61.7 mm), a wire thickness of approximately ⅝ inch (0.625 in=15.9 mm, or approximately 16 mm), and an interior oval opening that is approximately 1.18 inch (30 mm) wide (aka interior width) and approximately 3.5 inches (90 mm) long (aka interior length). As the chain 128 wears during use, the pitch and interior length will increase. Carwash systems and conveyor mechanism 100 can tolerate approximately 0.25 inch (6.4 mm) of total longitudinal wear in the chain, resulting in a pitch increase to 3.75 inches (95 mm) or more, before the chain must be replaced as preventative maintenance before chain breakage or another malfunction occurs. The shape and dimensions of the C-shaped coupling portion 160 of lugs 130 may be approximately the same as the dimensions of the links 152, 158, particularly the interior length, exterior length, and wire thickness of the coupling portion 160, while the interior width of coupling portion 160 may be approximately 1.05 inch (26.7 mm), which is slightly narrower than the interior width of the links 152, 158 of chain 128.

In the embodiment illustrated, sprocket 120 includes four teeth 140 spaced apart around a hub 150 of sprocket. In other embodiments (not illustrated), sprocket 120 may include a greater or lesser number of teeth 140, such as three, five, six, seven, or eight teeth, for example. The pitch of the teeth 140 corresponds to the center-to-center distance between horizontally oriented drive links 152 (i.e. every other link in the chain 128), such that each tooth 140 extends through one of the drive links 152 as the chain 128 rides around the sprocket 120. Between each pair of adjacent teeth 140 of sprocket 120 is formed a gullet 156 that provides clearance to receive the alternating links 158 of the chain 128 (which connect the drive links 152) and coupling portions 160 of lugs 130 (which connect the segments of chain 128), which are both oriented in a generally upright/vertical position as they ride over sprocket 120.

FIG. 2 is a section view of the portion of conveyor mechanism 100 of FIG. 1 taken along line 2-2 of FIG. 1. With reference to FIGS. 1 and 2, sprocket 120 may include a plurality of mounting holes 162 formed in and spaced apart around hub 150 for bolting sprocket 120 onto a drive shaft 170 (FIG. 2) of a motor drive of the conveyor mechanism 100 for rotating sprocket 120 around a central rotational axis 166. A hex nut 172 threaded onto a stud 174 (or bolt) of the drive shaft 170 are shown in FIG. 2 along with a socket 176 of a socket wrench to illustrate tool clearances for assembly. (A drive ratchet of the socket wrench is omitted for simplicity.) In other embodiments (not illustrated), the sprocket 120 may be fitted onto a drive shaft rather than being bolted to it, in which case the hub 150 may include one or more drive slots or grooves formed along its central opening for engaging a drive key or splines of a drive shaft, and mounting holes 162 may be omitted in such an embodiment.

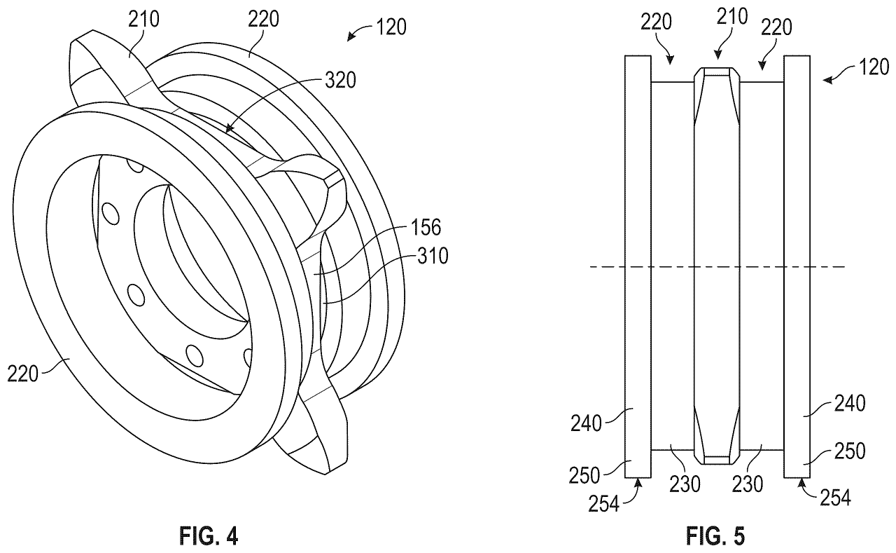

FIG. 3 illustrates roller assembly 200 and lug 130 as they ride over sprocket 120. As further described below with reference to FIGS. 4-7, sprocket 120 includes a central sprocket ring 210 that is sandwiched between two support rings 220 each having a hub portion 230 and a flange 240 at the axially outward end of the hub portion 230. The flanges 240 form a pair of shoulders 250 spaced apart from the sprocket ring 210 each having a radially outward facing shoulder surface 254 extending circumferentially around the flange 240. The shoulders 250 are preferably spaced apart a lateral (axial) distance roughly corresponding to the spacing of a pair of pusher rollers 270 of the roller assembly 200, which are further described below with reference to FIGS. 8 and 9. In one embodiment, the flanges 240 and shoulders 250 are each approximately 0.5 inch (12.7 mm) or greater in width W (thickness in the axial direction) and are spaced apart a distance A in the range of approximately 3 to 4 inches (76 to 102 mm) and more preferably about 3.625 inches (92 mm), whereas the sprocket ring 210 has a thickness T in the range of about 0.8 to 0.875 inch (20.3 to 22.22 mm) with tapered teeth 140. This spacing between the shoulders 250 provides clearance for the drive links 152 to nest or be received within a channel 260 formed between flanges 240 (and over hub portions 230), as illustrated in FIGS. 1-2, while positioning the shoulders 250 to underlie and provide support for pusher rollers 270 of the roller assembly 200, as illustrated in FIG. 3, to thereby prevent or limit tilting of the lug 130 (e.g., caused by twisting of chain 128 or other forces on lug 130) as the roller assembly 200 rides over sprocket 120. The flanges 240 preferably extend from hub portion 230 by a radial distance or height H in the range of about 0.5 to 0.7 inch (12.7 to 17.8 mm), or more preferably about 0.5 to 0.6 inch (12.7 to 15.2 mm), which is slightly less than the ⅝″ thickness of the drive links 152 in a ⅝″ log chain. In other embodiments (not illustrated) the shoulders 250 may be spaced apart a different distance A, and/or may have a different radial height H above hub portion 230 and/or a different width W, and may be sized to underlie and support a different part of roller assembly 200 such as a pair of deck-engaging main rollers 280 (aka main wheels or outrigger wheels), to achieve the same or similar result of inhibiting tilting of the roller assembly 200 as it rides over the sprocket 120.

In some embodiments, the height H of shoulders 250 and their radial position relative to hub portion 230 and teeth 140 of sprocket 120, and the dimensions of roller assembly 200, are such that pusher rollers 270 (or other supported roller wheels or portions of roller assembly 200, in other embodiments) do not normally contact shoulders 250 when roller assembly 200 is not tilted laterally relative to sprocket 120, but will only contact or bear against one of the shoulders 250 when the roller assembly 200 tilts laterally by a tilt angle limit Θ—for example, allowing lateral tilt of only up to a maximum lateral tilt angle in the range of approximately 1 to 10 degrees, or in the range of approximately 2 to 5 degrees, or more preferably in the range of approximately 1 to 4 degrees, or less. In other embodiments, shoulders 250 may have a height H sized to contact pusher rollers 270 (or other supported portions of roller assembly 200) without tilting of roller assembly 200, i.e., to normally contact and support pusher rollers 270 as roller assembly 200 rides over sprocket 120 to maintain roller assembly in an upright position without any appreciable lateral tilt.

FIGS. 4-7 further illustrate sprocket 120. With reference to FIGS. 2-7 and particularly FIGS. 2, 3 and 6, sprocket 120 is preferably formed of a three piece construction comprising toothed sprocket ring 210, which may be cast or forged from steel, and two identical support rings 220, which may be cast or forged from steel, or machined and heat treated, or made of durable high-impact plastic such as UHMWPE. Central sprocket ring 210 is flanked by the support rings 220 which may be welded together at various points where the support rings 220 contact sprocket ring 210, as illustrated by welds 284 shown in FIG. 2. Alternatively, support rings 200 may be connected to central sprocket ring 210 via bolts or other fasteners. In other embodiments, the entire sprocket 120 (including sprocket ring 210 and support rings 220) may be cast or otherwise formed of a unitary one-piece construction for improved strength.

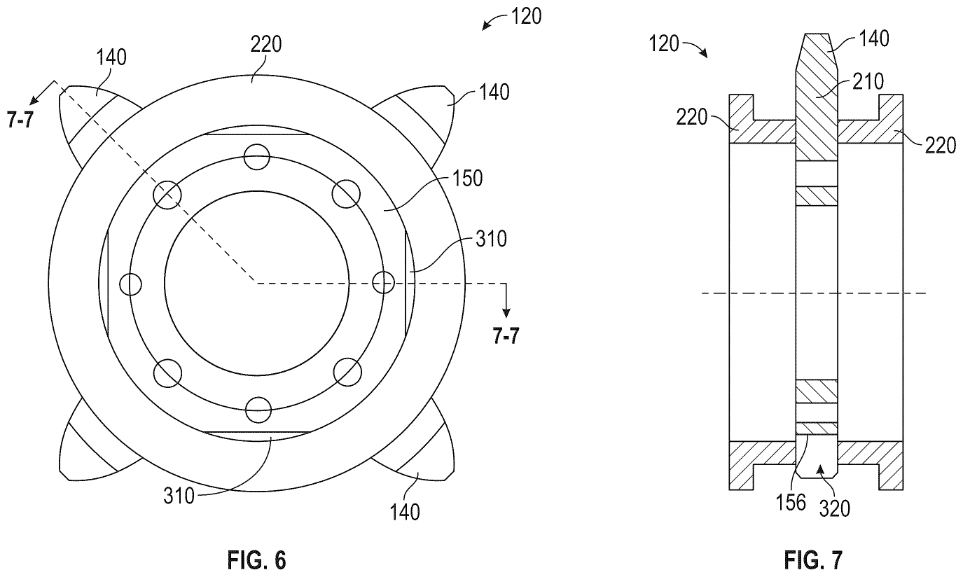

The support ring 220 and hub portion 230 may have an inner diameter that is larger than the root diameter of sprocket 120 (aka the gullet diameter or minor diameter of sprocket 120 to the base of the gullets 156). In other words, a first radial distance RH from the axis 166 to the inner diameter of support ring 220 and hub portion 230 may be slightly greater than a second radial distance RG from the axis 166 to the lowest points of the gullets 156. This dimensional arrangement leaves small lateral openings 310 at the base of the gullets 156 on either side of sprocket ring 210, as best illustrated in FIGS. 3 and 6. Lateral openings 310 may provide a passageway for debris, such as wear debris, to escape from gullets 156, thereby preventing debris from collecting and being packed in gullets 156 by repetitive seating of alternating links 158 and coupling portion 160 of lugs 130, which could otherwise have detrimental effects on the performance of sprocket 120 and tilting of roller assembly 200 relative thereto. In one embodiment, sprocket ring 220 may have a root diameter in the range of approximately 5.8 to 6.0 inch (14.7 to 15.2 cm), or more preferably approximately 5.88 inch (14.9 cm); and hub portion 230 may have an inner diameter in the range of approximately 6.1 to 6.4 inch (15.5 to 16.3 cm), or more preferably approximately 6.25 inch (15.9 cm).

Hub portion 230 may be sized so that an outer diameter of hub portion 230 is located less than half of the radial distance from the gullets 156 to the tip of the teeth 140 of sprocket 120, and more preferably between 15 percent and 45 percent of the distance from the gullets 156 to the top of the teeth 140. The arrangement of hub portion 230 relative to sprocket ring 210, teeth 140 and gullets 156, thus creates pockets 320 for a portion of the upright alternating links 158 and coupling portion 160 of lug 130 to be received as they pass over sprocket 120, which may help to ensure alignment of roller assembly 200 with flanges 240 and shoulders 250, and to prevent twisting of chain 128 and tilting of lug 130 and roller assembly 200. The outer diameter of hub portion 230 may be sized so that the hub portions 230 of support rings 220 form a support platform alongside the teeth 140 of sprocket ring 210 for supporting drive links 152 so that drive links 152 are not wedged onto teeth 140 as chain 128 is driven by sprocket 120. In one embodiment, the hub portion 230 may have an outer diameter of approximately 7.0 to 7.5 inch (17.8 to 19.1 cm), or more preferably 7.1 to 7.3 inch (18.0 to 18.5 cm). Gullets 156 may be sized and shaped to closely cradle and follow the contours of the upright alternating links 158 and coupling portions 160 to minimize wear on chain 128 and teeth 140. As such, upright alternating links 158 and the coupling portion 160 of each lug 130 are typically received and/or seated in the gullet 156 as the chain 128 rides around sprocket 120, providing increased contact area between chain 128 and sprocket 120 and reducing wear.

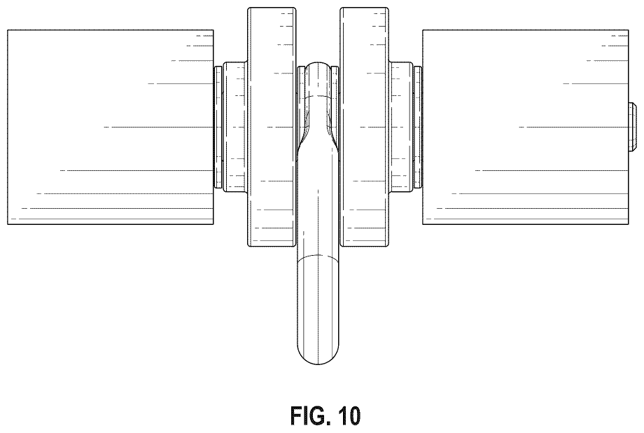

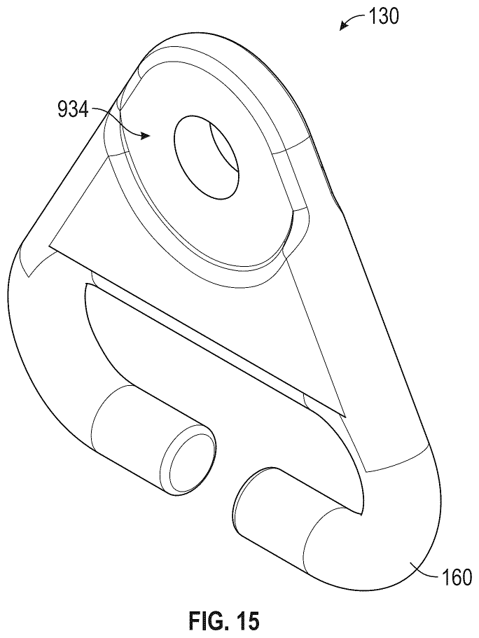

FIGS. 8-19 illustrate roller assembly 200 in greater detail, wherein FIG. 8 is an isometric view, FIG. 9 is a partially exploded assembly view, FIGS. 10-14 are orthographic projections, and FIGS. 15-19 show an isometric view and orthographic projections of the lug 130 of roller assembly 200. With particular reference to FIGS. 8 and 9, roller assembly 200 may include an axle pin 910 in the form of a hex-head bolt that extends through a hole 920 in a main body of lug 130. A pair of stainless steel inner washers 930 may be fitted onto axle pin 910 adjacent either side of lug 130 and seat in recesses 934 formed in the sides of lug 130. A pair of first bushings 940 and a pair of second bushings 950, all preferably made of case-hardened steel, are slidably assembled onto axle pin 910 and are positioned underlying the respective pusher rollers 270 and main rollers 280 (which are made of a durable polymer material, such as polyurethane or UHMWPE) to provide reduced friction and improved wear resistance. Stainless steel dividing washers 960 are positioned between the first and second bushings 940, 950 on either side of lug 130 to reduce friction by preventing contact between the polymer rollers 270, 280 and by preventing contact between the first and second bushings 940, 950. Spacer washers 970 are located on axle pin 910 adjacent outer ends of main rollers 280 and a nut 980 is threaded onto axle pin 910 to complete the roller assembly 200 and retain the parts on axle pin 910.

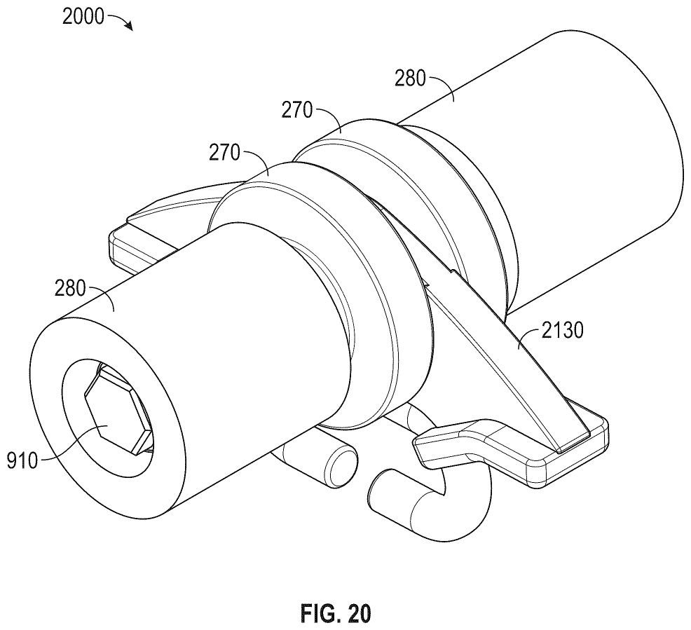

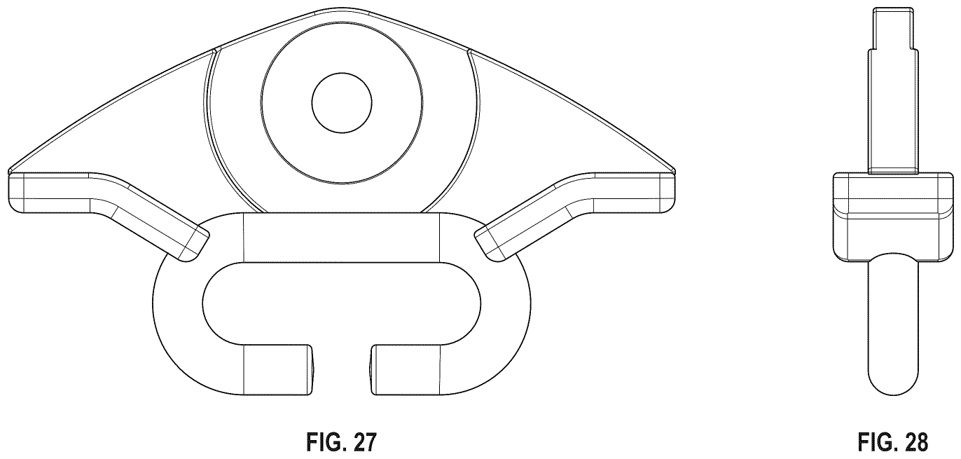

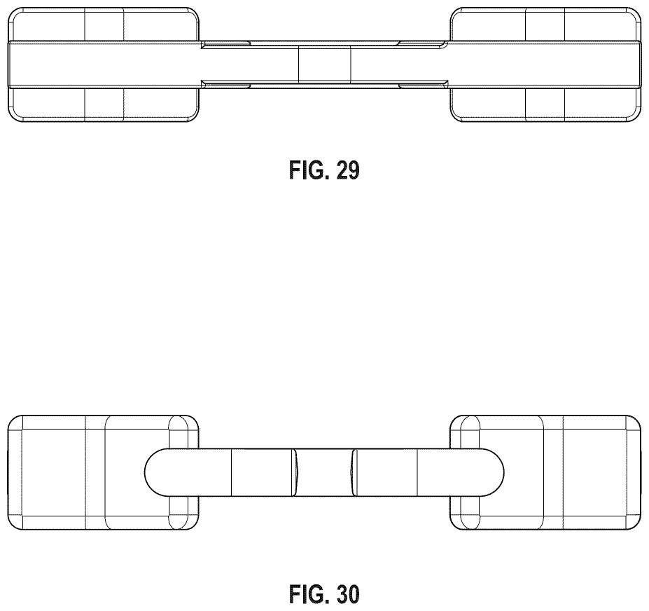

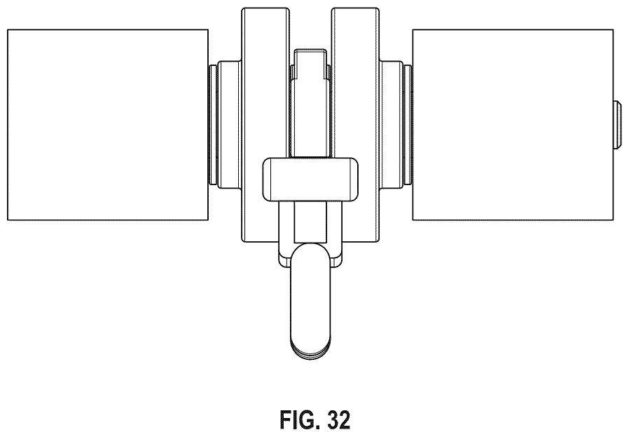

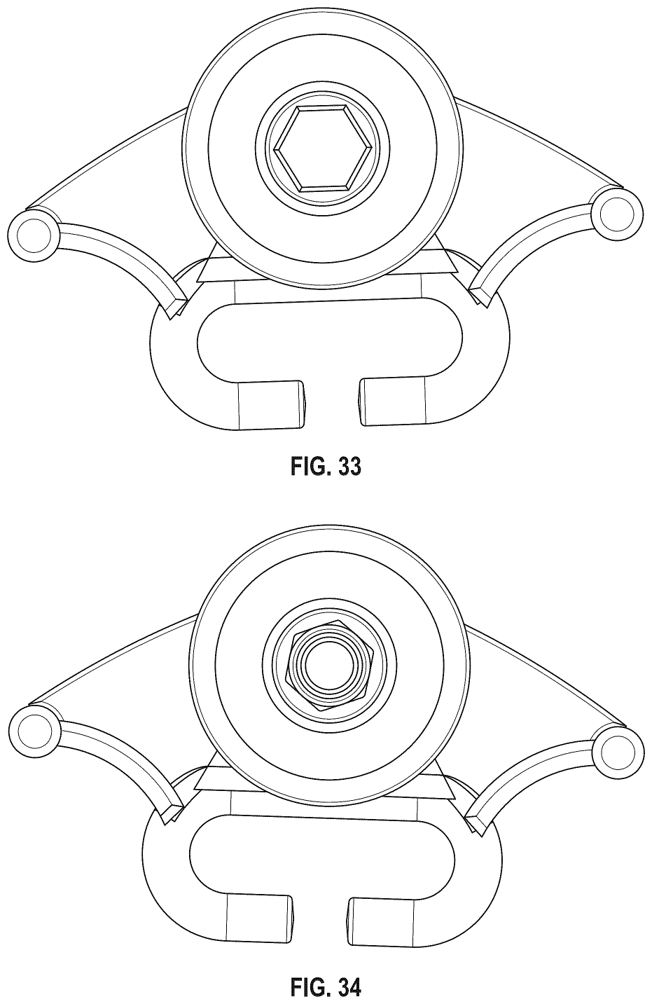

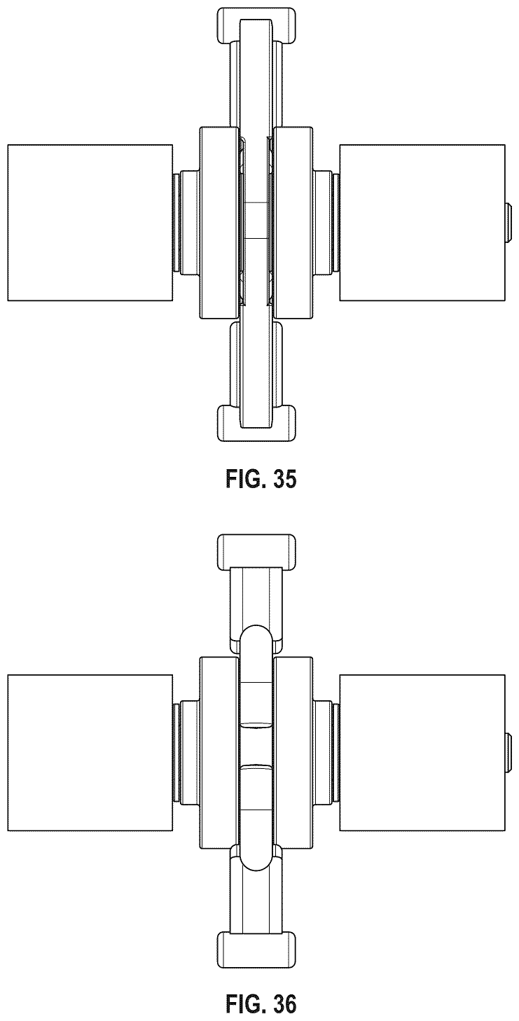

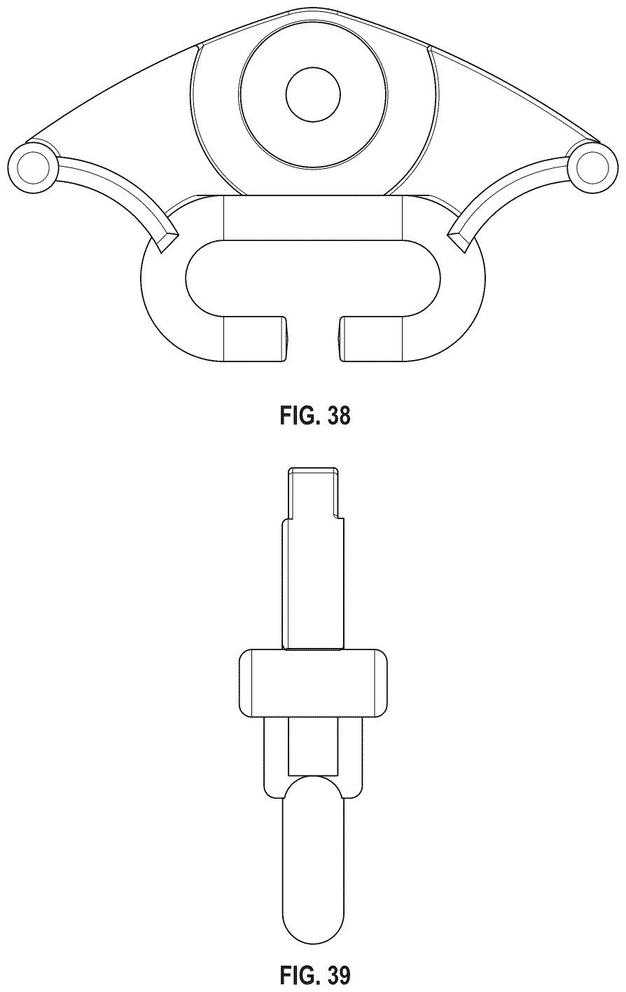

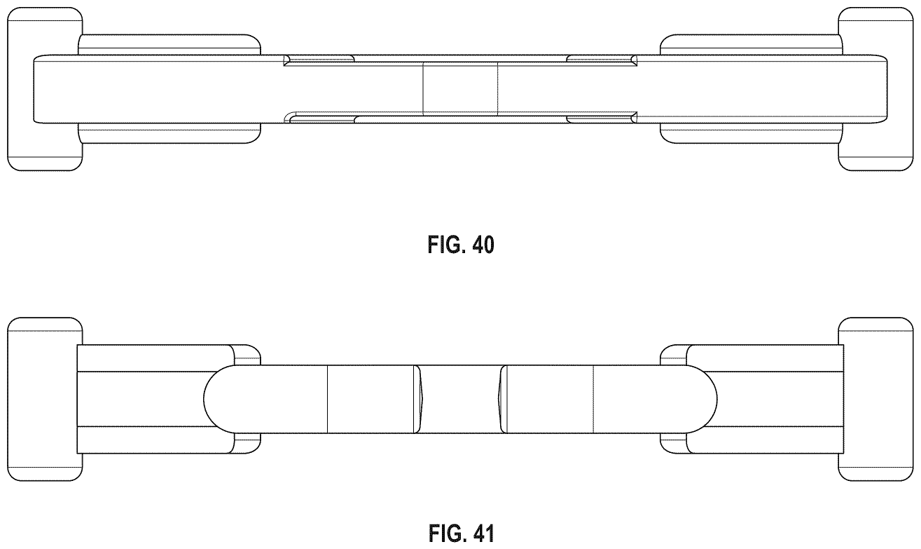

Roller assembly 200, and particularly the lug 130 thereof, are designed for use with a soft-drop style over/under conveyor. Lug 130 may have an overall length of approximately 4.73 inch (12.0 cm) in the direction of travel and a height in the range of approximately 3.5 to 4.0 inch (8.9 to 10.1 cm) or more preferably approximately 3.7 inch (9.4 cm), from the lowermost surface (base) of coupling portion 160 of lug 130 to the center of hole 920. Alternative embodiments of roller assemblies and lugs, designed for use with trap-door style over/under conveyors, are described below with reference to FIGS. 20-41 and may have heights that are similar to or different from the height of lug 130 (between base of coupling portion 160 and hole 920).

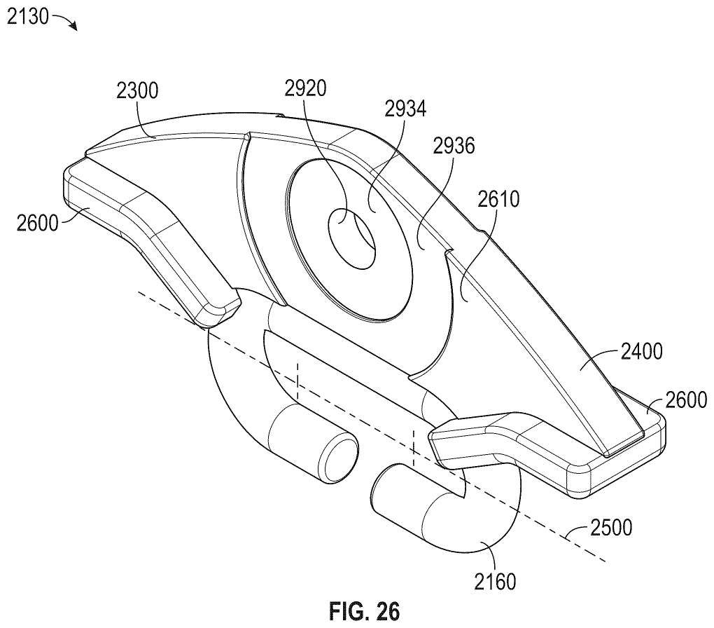

With reference to FIGS. 20-30, and particularly FIG. 20, a double-nosed roller assembly 2000 for a trap-door style over/under conveyor system is similar in its components and construction as roller assembly 200, except that lug 2130 is of a different shape and functional design, as described below. All other components are common to roller assembly 200 and double-nosed roller assembly 2000 and are illustrated in FIG. 20 with the same reference numerals as appear in FIGS. 8-9. With reference to FIGS. 20 and 26, lug 2130 is preferably formed of a unitary cast or forged steel construction, or may be assembled by welding together multiple steel component parts. Lug 2130 includes a main body portion 2610 in which a pin-receiving hole 2920 is formed. Main body portion 2610 overlies and is permanently connected to a C-shaped coupling portion 2160 for linking together segments of chain 128 in a conveyor mechanism. A stepped pair of recesses 2934 and 2936 may be formed on either side of main body portion 2610 of lug 2130 for receiving inner washers (930 in FIG. 9) and providing clearance for pusher rollers 270, respectively. First and second noses 2300 and 2400 extend longitudinally (in the direction of longitudinal axis 2500 of coupling portion 2160) from the forward and rearward ends of main body portion and beyond the longitudinal ends of coupling portion 2160 to project beyond the outer diameter or pusher rollers 270. Each of the first and second noses 2300, 2400 is wedge shaped, having a ramped top surface 2310, 2410 that is ramped upwardly to the main body portion 2610. A forwardmost one of the noses 2300, 2400 facing the direction of travel of the roller assembly 2000 drives open a trap door of a conveyor system (not illustrated) as the roller assembly 2000 reaches the end of the conveyor deck and comes into contact with the trap door assembly. In particular, the forwardmost one of the noses 2300, 2400 may contact a roller wheel of the trap door assembly and the roller wheel then rides up and over the lug 2130 to lift the trap door. Due to steel-on-steel contact between the forwardmost nose and the trap door (or roller wheel thereof), the forwardmost nose is subject to significant wear and is commonly the first component of the roller assembly to wear out. By including noses 2300 and 2400 at both ends of the lug 2130, the design is made reversible, so that the roller assembly 2000 can be quickly reversed when the forwardmost one of the noses 2300, 2400 becomes worn, effectively doubling the operating life of the roller assembly 2000. This double-nosed arrangement may also provide a gentler entry and exit of the roller assembly 2000 through the trap door, relative to conventional single-nosed designs, thereby reducing or eliminating slapping contact between the trap door and the lug as the trap door roller clears the lug 2130, thus further reducing noise and wear. As noted, the entire lug, including main body portion 2610 noses 2300, 2400 and coupling portion 2160 may be formed together of a one-piece unitary steel construction by casting or forging for strength and reliability.

Each of the first and second noses 2300 and 2400 may have a width/thickness that is the same as the width/thickness of the main body portion 2610 and may each include a lateral projection in the form of a flange 2600 formed along its underside. In other embodiments, the widths may vary. The flanges 2600 are wider than the main body portion 2610 and noses 2300, 2400, and extend laterally from the sides of the noses 2300 and 2400 to provide increased surface area, strength and wear resistance at the initial point of contact between noses 2300, 2400 and the trap door roller. Flanges 2600 may be sized to be approximately the same width or slightly wider than a metal roller wheel of the exit trap door of the conveyor mechanism so as to provide a maximum contact area and even wear across the width of the metal roller wheel.

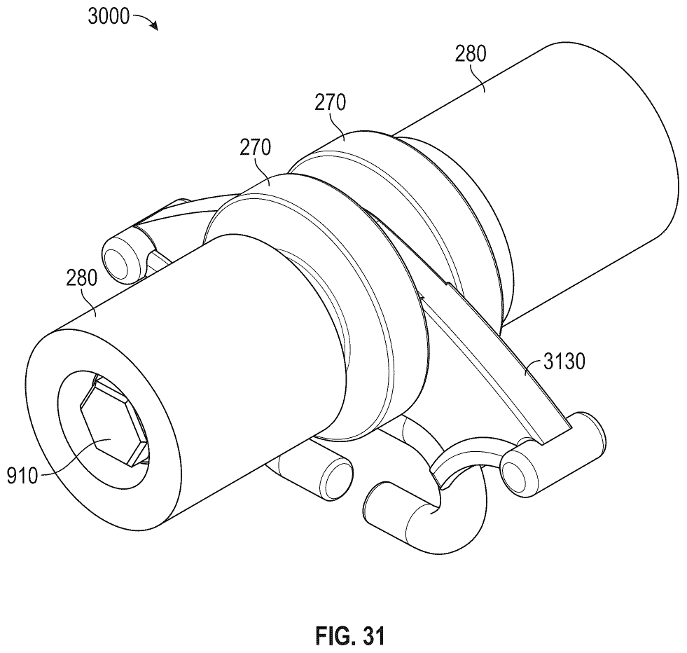

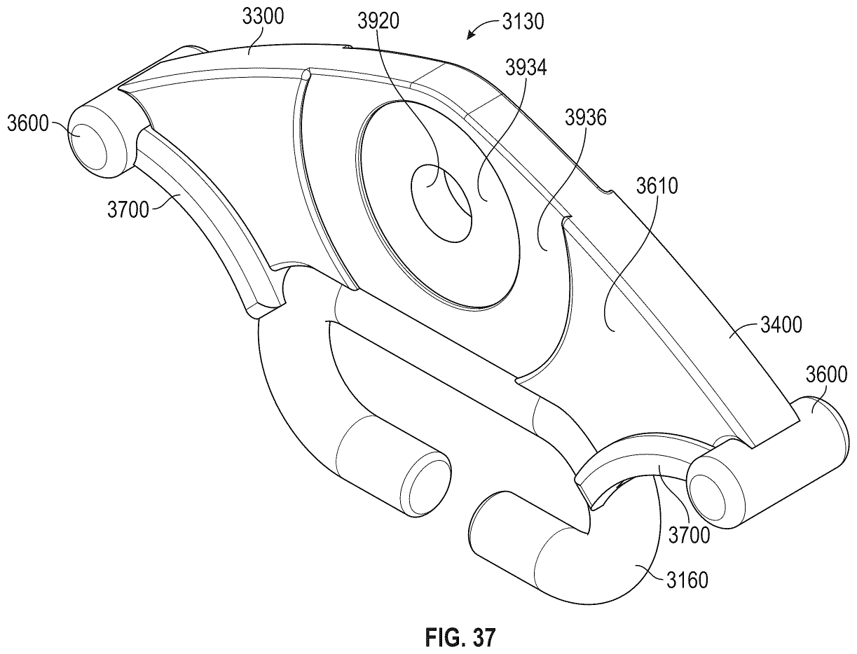

With reference to FIGS. 31-41, and particularly FIG. 31, a double-nosed roller assembly 3000 according to anther embodiment is similar in its components and construction and functional design as double-nosed roller assembly 2000 of FIGS. 20-30, except that lug 3130 is of a slightly different shape and structural design, as described below. All other components are common with roller assembly 2000 and roller assembly 200, and are illustrated in FIG. 31 with the same reference numerals as appear in FIGS. 8-9 and 20. With reference to FIGS. 31 and 37, first and second noses 3300 and 3400 of lug 3130 each includes a lateral projection in the shape of a hammerhead-shaped cylindrical member or bulb 3600 at the distal ends thereof. Each of the noses 3300, 3400 also includes a strengthening rib 3700 running along an underside thereof and extending from the bulb 3600 to where the respective nose 3300 or 3400 meets the coupling portion 3160 and the main body portion 3610. The bulbs 3600 may be cylindrically shaped (as illustrated) or provided in a different shape, such as an ellipsoid, sphere, or hemisphere, or some other knob shape. Each bulb 3600 may have a lateral extent (length) that is greater than the width of main body portion 3160 and the width of noses 3300, 3400 and ribs 3700. Bulbs 3600 preferably extend laterally from the sides of noses 3300, 3400 a distance greater than rib 3700. Each of the bulbs 3600 may be sized in the lateral extent (overall bulb length) to be approximately the same as or greater than the width of a metal roller wheel of the exit trap door of the conveyor mechanism so as to provide a maximum contact area and even wear across the metal roller wheel.

It will be obvious to those having skill in the art that many changes may be made to the details of the above-described embodiments without departing from the underlying principles of the invention. The scope of the present invention should, therefore, be determined only by the following claims.

The invention claimed is:

1. A sprocket for a conveyor chain of a carwash conveyor, comprising:
a sprocket ring configured to engage links in the conveyor chain as the conveyor chain rides over the sprocket ring; and
first and second support rings flanking opposite sides of the sprocket ring, each of the first and second support rings including a hub portion and a flange at an axially outer end of the hub portion, the flanges of the first and second support rings being spaced apart axially from the sprocket ring so as to form a channel between the flanges, and each flange defining a radially-outward facing shoulder surface.

2. The sprocket of claim 1, wherein the channel is sized to receive drive links of the conveyor chain through which the teeth of the sprocket ring extend as the conveyor chain rides over the sprocket.

3. The sprocket of claim 1, wherein the sprocket ring includes a hub, a plurality of teeth spaced apart around the hub and extending radially from the hub, and a plurality of gullets, each gullet located between adjacent ones of the teeth and sized to receive alternating links of the conveyor chain.

4. The sprocket of claim 3, wherein the sprocket ring has a root diameter corresponding to a radial location of the gullets, and the hub portion has an outer diameter that is greater than the root diameter.

5. The sprocket of claim 4, wherein the outer diameter of the hub portion is located less than half of the radial distance from the gullets to tips of the teeth.

6. The sprocket of claim 4, wherein the hub portion has an inner diameter that is greater than the root diameter.

7. The sprocket of claim 6, wherein the outer diameter of the hub portion is located less than half of the radial distance from the gullets to tips of the teeth.

8. The sprocket of claim 6, further comprising lateral openings at the base of the gullets on either side of the sprocket ring.

9. The sprocket of claim 1, wherein:
the sprocket ring, including the hub and the teeth thereof, is formed of a unitary one-piece construction,
the first support ring, including the hub portion and flange thereof, is formed of unitary one-piece construction, and
the second support ring, including the hub portion and flange thereof, is formed of unitary one-piece construction.

10. The sprocket of claim 9, wherein each of the sprocket ring and the first and second support rings is made of cast or forged steel.

11. The sprocket of claim 9 wherein each of each of the first and second support rings is attached to the sprocket ring by one or more welds.

12. The sprocket of claim 1, wherein the sprocket ring and the first and second support rings are all formed together of a unitary one-piece construction.

13. The sprocket of claim 1, wherein the flanges form a pair of shoulders spaced apart and axially away from the sides of the sprocket ring, the shoulder of each support ring having a radial position, relative to the hub portion, that limits tilting of a roller assembly of the carwash conveyor to a maximum lateral tilt angle in the range of 1 to 10 degrees as the roller assembly rides over the sprocket.

14. The sprocket of claim 1, wherein the flanges of the first and second support rings extend radially from the respective hub portions by a radial distance in the range of 0.5 inch to 0.7 inch.

15. A reversible roller assembly for a carwash conveyor system, comprising:
a lug formed of unitary one-piece construction, the lug including a main body portion having a hole formed therein, a coupling portion for linking together leading and trailing segments of a conveyor chain of the carwash conveyor system, a first nose extending forwardly of the main body portion and beyond a leading end of the coupling portion, and a second nose extending rearwardly of the main body portion and beyond a trailing end of the coupling portion, wherein each of the first and second noses includes a top surface that is ramped upwardly to the main body portion;
an axle pin extending through the hole in the main body portion of the lug; and
multiple roller wheels rotatably mounted to the axle pin, at least one of the roller wheels positioned on each side of the lug,
wherein the roller assembly can be detached from the conveyor chain, then reversed and reattached to the leading and trailing segments of the conveyor chain so that the first nose extends rearwardly of the body portion and the second nose extends forwardly of the body portion.

16. The roller assembly of claim 15, wherein the lug, including the main body portion, the first and second noses, and the chain coupling portion, is cast or forged of steel.

17. The roller assembly of claim 15, wherein the lug further comprises a first lateral projection at a distal end of the first nose and a second lateral projection at a distal end of the second nose, each of the first and second lateral projections extending laterally from opposing sides of the respective first and second noses.

18. A reversible lug for a roller assembly of a carwash conveyor system, the lug being formed of unitary one-piece construction, the lug comprising:
a main body portion having a hole formed therein and sized to receive an axle pin for carrying roller wheels;
a coupling portion for linking together leading and trailing segments of a conveyor chain of the carwash conveyor system;
a first nose extending forwardly of the main body portion and beyond a leading end of the coupling portion; and
a second nose extending rearwardly of the main body portion and beyond a trailing end of the coupling portion,
wherein each of the first and second noses includes a top surface that is ramped upwardly to the main body portion.

19. The lug of claim 18, further comprising a first lateral projection at a distal end of the first nose and a second lateral projection at a distal end of the second nose, each of the first and second lateral projections extending laterally from opposing sides of the respective first and second noses.

20. The lug of claim 18, wherein the lug, including the main body portion, the first and second noses, and the chain coupling portion, is cast or forged of steel.
